(19) United States
(12) Patent Application Publication
(10) Pub. No.: US 2010/0030661 A1
(43) Pub. Date: Feb. 4, 2010

(54) MANAGING PRODUCT ORDERS THROUGH MULTIPLE SUPPLIERS

(75) Inventors: FRANK FRIEDLAND, Boca Raton, FL (US); Michael B. Chasan, Boca Raton, FL (US)

Correspondence Address: Fleit Gibbons Gutman Bongini & Bianco PL, 21355 EAST DIXIE HIGHWAY, SUITE 115, MIAMI, FL, 33180, US

(73) Assignee: ESAVE.NET, LLC, Boca Raton, FL (US)

(21) Appl. No.: 12/258,559

(22) Filed: Oct. 27, 2008

Related U.S. Application Data
(60) Provisional application No. 61/084,293, filed on Jul. 29, 2008.

(51) Int. Cl. G06F 17/30; G06Q 30/00; G06Q 10/00; G06Q 90/00

(52) U.S. Cl. 705/27; 705/26; 705/1

(57) ABSTRACT

A method, information processing system, and computer readable storage product provide an interactive environment and for autonomously manages user orders associated with at least one vendor. An order is received from a user for at least one item offered by at least one vendor through the interactive environment. Vendor account information associated with the user for the at least one vendor is retrieved. The at least one vendor is autonomously and without user intervention is logged into using the vendor account information associated with the user. Information associated with the order is autonomously and without user intervention provided as prompted by the vendor on behalf of the user to place the order with the at least one vendor.

### CROSS-REFERENCE TO RELATED APPLICATIONS

This application is based upon and claims priority from prior U.S. Provisional Patent Application No. 61/084,293, filed on Jul. 29, 2008 entitled “Method For Ordering Products From A Plurality Of Suppliers”, the entire disclosure of which is herein incorporated by reference.

### FIELD OF THE INVENTION

The present invention generally relates to the field of product procurement, and more particularly relates to managing product orders for a customer through multiple suppliers.

### BACKGROUND OF THE INVENTION

Restaurants generally have relationships with more than one vendor/supplier such as a food purveyor. In other words, a restaurant obtains supplies from more than one vendor. Usually, a restaurant operator places an order for products/items from a vendor via a website/application associated with that vendor. However, because products/items are obtained from various vendors, the restaurant operator is generally required to separately log into each of the different vendors' website/application to place an order. Also, if a restaurant operator wants to compare products/items between vendors, the operator is generally required to switch between websites/applications to perform the comparison.

### SUMMARY OF THE INVENTION

In one embodiment, a method with an information processing that provides an interactive environment autonomously manages user orders associated with at least one vendor is disclosed. The method comprises receiving an order from a user for at least one item offered by at least one vendor through the interactive environment. Vendor account information associated with the user for the at least one vendor is retrieved. The at least one vendor is autonomously and without user intervention is logged into using the vendor account information associated with the user. Information associated with the order is autonomously and without user intervention provided as prompted by the vendor on behalf of the user to place the order with the at least one vendor.

In another embodiment, an information processing system that provides an interactive environment and autonomously manages user orders associated with at least one vendor is disclosed. The information processing system comprises a memory, a processor, an interactive environment, and an interactive environment manager. The interactive environment manager is adapted to receive an order from a user for at least one item offered by at least one vendor through the interactive environment. Vendor account information associated with the user for the at least one vendor is retrieved. The at least one vendor is autonomously and without user intervention is logged into using the vendor account information associated with the user. Information associated with the order is autonomously and without user intervention provided as prompted by the vendor on behalf of the user to place the order with the at least one vendor.

In yet another embodiment, a computer readable storage product that provides an interactive environment autonomously manages user orders associated with at least one vendor is disclosed. The computer readable storage product comprises instructions for receiving an order from a user for at least one item offered by at least one vendor through the interactive environment. Vendor account information associated with the user for the at least one vendor is retrieved. The at least one vendor is autonomously and without user intervention is logged into using the vendor account information associated with the user. Information associated with the order is autonomously and without user intervention provided as prompted by the vendor on behalf of the user to place the order with the at least one vendor.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 illustrates a user interface of one example of an interactive environment according to one embodiment of the present invention;

FIG. 3 illustrates a user interface of one example of an order guide according to one embodiment of the present invention;

FIG. 4 illustrates a user interface of one example of form to create an order according to one embodiment of the present invention;

FIG. 5 shows an example of an order form according to one embodiment of the present invention;

FIG. 6 illustrates a user interface of one example of an order summary according to one embodiment of the present invention;

FIG. 7 shows one example an interactive environment displaying pricing change information associated with an order according to one embodiment of the present invention;

FIG. 8 shows one example an order summary organizing items by food purveyor according to one embodiment of the present invention;

FIG. 9 is shows one example an interactive environment displaying a recipe cost analysis according to one embodiment of the present invention;

FIG. 10 is an operational flow diagram illustrating one process for placing an order on behalf of a user at one or more food purveyors according to one embodiment of the present invention;

FIG. 11 is an operational flow diagram illustrating another process for placing an order on behalf of a user at one or more food purveyors according to one embodiment of the present invention;

FIG. 12 is an operational flow diagram illustrating one process for managing a user order for items associated with a plurality of purveyors according to one embodiment of the present invention;

FIG. 13 is an operational flow diagram illustrating one process for autonomously retrieving information associated with a user and/or products from a purveyor using account information of a user according to one embodiment of the present invention; and

FIG. 14 is a block diagram illustrating a more detailed view of an information processing system according to one embodiment of the present invention;

### DETAILED DESCRIPTION

As required, detailed embodiments of the present invention are disclosed herein; however, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure and function. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

Operating Environment

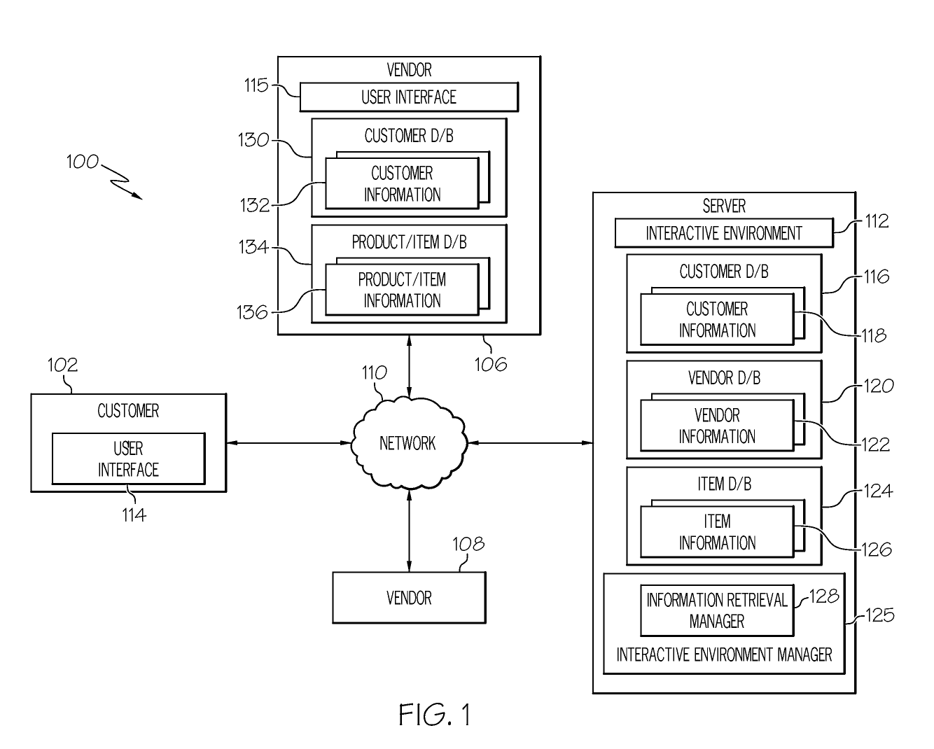

According to one embodiment of the present invention, as shown in FIG. 1, a system 100 for managing customer product orders through a plurality of suppliers is shown. In particular, the system 100 provides an interactive environment where customers can compare products/items from multiple suppliers and place orders therewith.

In one embodiment, the system 100 includes a plurality of information processing systems 102, 104, 106, 108. Each of the information processing systems 102, 104, 106, 108 is communicatively coupled to each other via one or more networks 110. The network(s) 110, in one embodiment, is a wide area network, local area network, wireless network, or the like. The information processing systems 102, 104, 106, 108 include one or more customer systems 102, server systems 104, and vendor systems 106, 108. A customer system 102, in one embodiment, is associated with a restaurant that is a customer of a vendor/supplier such as a food purveyor. The vendor systems 106, 108 are associated with the vendor/supplier. It should be noted that although the present discussion uses examples such as a restaurant for the customer and a food purveyor for a vendor/supplier the various embodiments of the present invention are not limited to such examples.

The server system 104 includes an interactive environment 112 that users (e.g., restaurant operators) of the customer system 102 interact with via a user interface 114. The interactive environment 112, in one embodiment, is a website, web application, a mashup, or the like where users can view product/item information from different food purveyors and manage orders for each of the different food purveyors. In another embodiment the interactive environment is a customer's computer with the specialized software described on the server residing on the customer's computer coupled to the Internet. The product/item information is displayed in a format that allows the user to easily compare similar items from each of the purveyors. This is advantageous because a restaurant operator usually has accounts with multiple food purveyors. The restaurant operator is generally required to separately log into to his/her account at each of the food purveyor's websites or applications and place a separate order using each of the different accounts. If the restaurant operator wants to compare items between each of the food purveyors to identify who has the best price or the best deal, the operator has to switch between each of the food purveyor's website/application.

However, the interactive environment 112 of the various embodiments of the present invention displays the product/item information from the different food purveyors at a central location so that the restaurant operator can view information from the different purveyors at substantially the same time and manage product/item orders accordingly. Also, restaurant operators usually have one or more on-going orders with multiple food purveyors. Therefore, the restaurant operators are required to log into each separate food purveyor's websites/applications and manage their order forms accordingly. The interactive environment 112, on the other hand, presents the order forms of a restaurant operator for the various food purveyors at a central location and, in some embodiments, as a consolidated order form. These and other aspects of the interactive environment 112 are discussed in greater detail below.

The server system 104 also includes a customer database(s) 116 that includes customer information 118 such as (but not limited to) customer account information associated with the interactive environment 112; customer log-in/password information for one or more purveyor websites/application; customer order information created at one or more food purveyors' website/application; customer recipe information, and customer order information created through the interactive environment 112. The server system 104 also includes a vendor database 120 that includes information 122 associated with vendors (food purveyors/suppliers). For example, food purveyors can also have an account with the interactive environment 112 for creating/managing/submitting ads, specials, discounts, and the like that are presented to the customers. Therefore, the vendor database 120 can include account information, ad campaign information, product/item related information, and the like. A product/item database 124 is also included within the server system 104. The product/item database 124 includes product/item information 126 such as description information, packaging information, SKU information, images, pricing information, comparable product information, and the like. The customer information 118, vendor information 122, and the product/item information 126 are discussed in greater detail below.

The server system 104 also includes an interactive environment manager 125 for managing customer/vendor interaction with the interactive environment 112 and also for managing the display of information to a customer/vendor. The interactive environment manager 125, in one embodiment, includes an information retrieval manager 128 manages the retrieval of product/item and customer information from a food purveyor 106, 108. It should be noted that the information retrieval manager 128 can reside outside of the interactive environment manager 125 as well. The information retrieval manager 128 can retrieve information at predefined intervals/frequencies and/or dynamically in response to an action taken by a customer at the interactive environment 112. The interactive environment manager 126 and the information retrieval manager 128 are discussed in greater detail below.

The server system 104 can also maintain commission information (not shown) that tracks the interactive environment employees' commission information. For example, as each employee sells a subscription to the interactive environment information such as the number of subscriptions, the length of subscription, the price of the subscription, the customer/vendor buying the subscription, salesperson referrals, and the like is maintained in the commission information. Commissions can be based on a percentage of the subscription fee or any other amount/percentage. Commission reports can also be printed by administrators to track an employee's commissions and progress.

The vendor systems 106, 108, in one embodiment, include one or more customer databases 130. The customer databases 130 include customer information 132 such as (but not limited to) login/password information, account information, order information, and payment information. Order information can be, for example, current on-going orders that are placed daily, weekly, monthly, yearly, and or the like. Order information can also include order history information as well. The vendor system 106, 108 can also include one or more product/item databases 134. The product/item databases 134 include product/item information 136 such as (but not limited to) description information, packaging information, SKU information, images, and pricing information. This order information and product/item information is retrieved by the information retrieval manager 128 as discussed above.

Interactive Environment

As discussed above, the interactive environment 112 at least partially automates the ability of a restaurant owner to survey a plurality of websites/applications associated with food purveyors. Restaurant operators can more easily and more accurately compare prices from multiple food purveyors and place/manage orders with multiple food purveyors at a centralized location. Food purveyors can also utilize the interactive environment 112 to submit ads, discounts, specials, and the like that are presented to the customers interacting with the interactive environment 112.

Initially, customers and vendors establish an account with the interactive environment. For example, a customer uses the interactive environment user interface “user I/F” 114 to establish an account with the interactive environment 114. The user I/F 114 can be a web-browser, an application, or the like. The account information can include restaurant name, number of locations, location names, location addresses, contact information (name, phone number, fax number, email, and the like) for either an administrator of all locations or for each location, user name for the administrator(s)/manager(s), passwords, password retrieval information, billing information (e.g., credit card number(s) and checking account information), and the like. It should be noted that the billing information can include billing information for the interactive environment 112 and/or for one or more food purveyors as well. Also, the billing information enables the interactive environment 112 use the payment method selected by the customer to charge the customer at given intervals for accessing the environment 112. The above information is stored in the customer database 116 as customer information 118.

It should be noted that a given restaurant can have multiple accounts each for a different location. Also, a single location can have multiple accounts and, in one embodiment, one or more of the accounts can have different access permissions/capabilities. For example, a manager of a restaurant can have restricted access to the interactive website while another employee can be assigned restricted access resulting in access to only a subset of the available features of the interactive environment.

When a vendor creates an account with the interactive environment 112, an administrator/manager or employee of the vendor, via the user I/F 115, enters account information. Vendor account information can include company information such as (but not limited to) company name, addresses, contact information (name, phone number, fax number, email, and the like) for at least one agent of the company, passwords, password retrieval information, billing information (e.g., credit card number(s) and checking account information), and the like. The billing information enables the interactive environment 112 to charge use payment method selected by the vendor to charge the vendor at given intervals for use of the environment 112. The above information is stored in the vendor database 120 as vendor information 122.

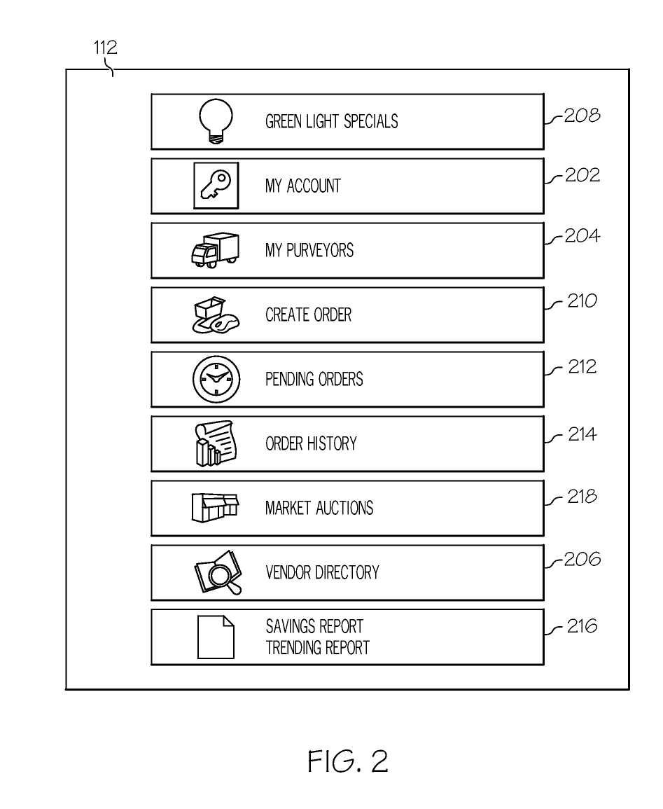

Once the customer/vendor creates an account the customer/vendor is able to interact with the interactive environment. For example, FIG. 2 illustrates a user interface of one example of the interactive environment 112 and options available to customers for interacting with the environment 112. In particular, FIG. 2 shows one or more widgets 202 that allows that customers to manage their accounts. For example, a restaurant operator (e.g., a customer) can add/delete locations, change passwords, change/add payment information, add/delete users, manage user access permissions, manage billing information, manage purveyor accounts information for each restaurant location, and the like. It should be noted that although “widgets” are used throughout the following discussion as a method for a customer/vendor to interact with the interactive environment 112 the present invention is not limited to such an embodiment. For example, drop-down menus, entry boxes, or any other type of interactive mechanism or input method is also applicable to the present invention as well.

With respect to managing purveyor account information, a restaurant operator can enter/change/delete login information such as user IDs, and passwords for each purveyor that a given location(s) orders products/items from. The restaurant operator can also manage purveyor information retrieval schedules. As discussed above, the information retrieval manager 128 retrieves order information for each registered customer from the purveyors that have been added to the customer's interactive environment account. A restaurant operator, in one embodiment, can set the frequency in which the information retrieval manager 128 retrieves customer related information from each purveyor. For example, a restaurant operator can set the frequency to daily, weekly, monthly, yearly, or any frequency there between. The restaurant operator can also set a time of day that the information is to be retrieved. In one embodiment, when the purveyors are first added to a customer account and customer information at the purveyor has not been retrieved, the interactive environment manager 125 sets a default retrieval schedule.

In one embodiment, the default retrieval schedule is set to the least populated weekly slot. For example, with respect to purveyor_1, if Monday at 3:00 a.m. for has the least number of “crawls” scheduled for purveyor_1 then the interactive environment manager 125 sets the default retrieval schedule to every Monday at 3:00 a.m. It should be noted that each purveyor can have a different default schedule based on the information retrieval operations scheduled for the purveyors. By selecting the least populated weekly slot the vendor systems 106, 108 experience less network traffic from the interactive environment 112. It should also be noted that setting the default retrieval schedule is set to the least populated weekly slot is only one example and the default schedule can be set to any frequency and at any given time.

Also, the interactive environment manager 125, in one embodiment, can override a customer defined retrieval schedule. For example, a restaurant operator may set a retrieval schedule for purveyor_1 for every Tuesday at 10:00 a.m. The interactive environment manager 125 can analyze the currently scheduled retrieval operations for purveyor_1. If the number of retrieval operations scheduled for Tuesday at 10:00 a.m. for purveyor_1 is above a given threshold, the interactive environment manager 125 can automatically adjust the retrieval schedule to another day and time with less retrieval operations scheduled. The customer can then be notified accordingly. Alternatively, the interactive environment manager 125 can notify a user that a schedule limit has been exceeded for that particular day and/or time and prompt the user to select a different day and/or time.

It should be noted that the widgets and options/actions available to a customer under the widgets are only examples and do not limit the present invention in any way. For example, one or more widgets can be added deleted with the same and/or different options/actions associated therewith. Also, one or more operations/actions under a widget discussed above can be provided under one of the other widgets discussed above as well.

FIG. 2 also shows another widget 204 that allows the customer to manage their purveyors. For example, the purveyors entered by a restaurant operator under the account options discussed above are presented to the operator when the purveyor widget 204 is selected. It should be noted that instead of a restaurant operator entering purveyor information under the account settings discussed above the operator can enter the purveyor information by selecting the purveyor widget 304. The restaurant operator is able to, among other things, add/delete purveyors, add/delete/modify retrieval schedules for a given purveyor, and enable/disable information retrieval operations for purveyors as well.

Another feature of the interactive environment 112 is that a restaurant operator is also able to search/research available vendors using the interactive environment 112. For example, a widget 206, in one embodiment, is included within the interactive environment 112 that when selected presents the restaurant operator with a plurality of options for identifying and selecting one or more additional vendors. The restaurant operator can enter geographic information such as a street address, zip code, state information, and the like and the interactive environment displays a list of vendors within a given distance from the geographic information entered. In one embodiment, the interactive environment manager 125 searches the vendor database 120 for vendors when a vendor search request is received from a customer.

The restaurant operator can also perform a keyword search to locate a vendor. A vendor can be a food purveyor, a service provider such as (but not limited to) a restaurant equipment repair service, a company that sells restaurant equipment, and the like. In this embodiment, the interactive environment manager 125 searches the vendor database 120, and in particular the vendor descriptions and/or keywords associated with each vendor in the vendor information 122. In another embodiment, vendor categories/sub-categories of vendors can be presented to a restaurant operator who can then select one or more of these categories/sub-categories. For example, a main category of “repair service” can be presented with sub-categories of “air conditioning repair”, “refrigerator repair”, and the like.

Based on the vendor search input received from the restaurant operator, the interactive environment manager 125 displays a list of vendors substantially matching the search terms given by the restaurant operator. In one embodiment, the interactive environment manager 125 also displays ads associated with one or more presented vendors. As discussed above, vendors are able to submit ads to the interactive environment where they are stored in the vendor database 120 as part of the vendor information 122. The interactive environment manager 125, in one embodiment, randomly selects ads to be displayed to the restaurant operator; selects ads based on keywords associated with an ad substantially matching a keyword entered by the restaurant operator; selects ads based on the category/sub-category selected by the restaurant operator for the vendor search; and/or the like.

In one embodiment, the interactive environment 112 displays specials provided by one or more food purveyors. Specials can include discounts on items, information on new products, buy N items get X items for free specials, and the like. In the example of FIG. 2, a widget 208 is presented to a restaurant operator that when interacted with signals the interactive environment manager 125 to display any food purveyor specials. As discussed above, the vendors such as food purveyors are able to submit discounts and specials to the interactive environment. The interactive environment manager 125 stores this information in the vendor database 120 as part of the vendor information 122. When presenting food purveyor specials to a restaurant operator the interactive environment manager 125 can choose to only display specials from purveyors listed under the restaurant operator's account. Alternatively, the interactive environment manager 125 can choose to display specials from purveyors listed under the restaurant operator's account and/or non-customer associated food purveyors. If the restaurant operator sees a special from a food purveyor currently not associated with his/her account, the restaurant operator is able to add the food purveyor to his/her account. Also, a restaurant operator can select which food purveyors the interactive environment manager 125 is to display specials from.

The interactive environment 112, as discussed above, also enables a restaurant operator to place orders for products, items, and/or services from one or more different vendors via a centralized location. The restaurant operator can initiate the order process by selecting one or more widgets 210, links, menus, or the like. The ordering process is discussed in more detail below.

The restaurant operator can also interact with the environment 112 by, for example, selecting a widget 212 that displays pending orders. A pending order is an order that has been saved by the restaurant operator at the interactive environment 112 but has not been submitted. Information such as (but not limited to) order save date, order name, order total, restaurant location, purveyors, and the like can be presented to the restaurant operator. The restaurant operator can also choose to interact with the pending order. If this option is selected the interactive environment 125 displays a shopping cart of items from the saved order. The restaurant operator can then add and/or delete items to/from the order, change quantities and packaging sizes, and the like. The restaurant operator is also able to submit the order for processing as well.

Order history can also be presented to the restaurant operator by, for example, interacting with a particular widget(s) 214 in the interactive environment 112. The order history information can be associated with orders placed through the interactive environment 112 and/or orders placed at a food purveyor's website/application by the restaurant operator. Information such as (but not limited to) order number, date/time the order was submitted, order total, order name, restaurant location, purveyors, and the like can be included in the order history. A link can be provided to the operator to view order details or the details can be presented on the same page as the more general information discussed above. Order details can include the above information, item information for each item ordered through a purveyor, and the like. Item information includes (but is not limited to) item number, brand name, item description, packaging details, quantity, price, extended price (price x quantity), and purveyor order total.

If the order history information includes order histories associated with orders placed at a purveyor's website application by the restaurant operator 112, the information retrieval manager 128 uses the operator's purveyor account information to obtain the data. For example, the information retrieval manager 128, either dynamically (e.g., when the restaurant operator request the order histories) or at a scheduled retrieval time acts as an agent on behalf of the operator and automatically logs into the purveyor's website/application. The information retrieval manager 128 uses the operator's account information for the purveyor that is stored in the customer database 116. As discussed above, the user submits this information to the interactive environment during the account setup procedure. However, this information can also be entered at any time by the operator. Also, the interactive manager 112 can dynamically prompt the user for purveyor account information when needed.

The information retrieval manager 128 interacts with the purveyor's website/application as if the restaurant operator is entering the required information. The information retrieval manager 128 selects the appropriate links/widgets/menus and/or submits the appropriate information to obtain the required order histories of the restaurant operator. The information retrieval manager 128 then stores this information in the customer database 116 as customer information for that particular restaurant operator.

Savings and trending reports are also presented to a restaurant operator while interacting with the interactive environment 112. For example, the restaurant operator can select one or more widgets 216 and be presented with a savings report and/or a trending report. With respect to savings reports, a restaurant operator is able to select a location or all locations and time periods and view a list of orders that have been submitted through the interactive environment 112. A savings report organizes the orders in a given manner such as (but not limited to) ascending order for a selected time period. Information such as (but not limited to) the information displayed for the order history discussed above is displayed to the operator. In addition, savings information that is calculated by taking the cost of each item in the order and subtracting this cost from the highest cost of that item among one or more purveyors.

For example, take an order comprising 2 items. The first item is associated with a quantity of 100, a purchased price of $2.00 per unit ($200.00 extended price), a highest price among the purveyors of $2.40 per unit ($240.00 extended price). Therefore, the report indicates that the savings for item is $40.00 ($240.00−$200.00=$40.00). With respect to the second item, the second item is associated with a quantity of 50, a purchased price of $4.50 per unit ($225.00 extended price), a highest price among the purveyors of $5.00 per unit ($250.00 extended price). Therefore, the report indicates that the savings for item is $25.00 ($250.00−$225.00=$25.00). The report also indicates a total savings of $65.00 ($40.00+$25.00=$65.00).

A trending report section of the interactive environment 112 allows the restaurant operator to select a given time period such as a 12-month period and enter an item number(s) to view the cost of that item(s) from the food purveyor(s) over the course of selected period of time. For example, the restaurant operator can enter search criteria such as (but not limited to) a time period range which can be a week(s), month(s), year(s); restaurant location; purveyors; item numbers; and the like. The information retrieval manager 128 then analyzes the cost of the item(s) over the given time period. The interactive environment manager 128 then displays a trending report that includes information such as (but not limited to) pricing information for each item entered by the user over the requested time period. The trending report can break this information down by day, week, month, and/or year.

The interactive environment 112, in one embodiment, also enables restaurant operators and vendors to participate in market auctions. For example, a restaurant operator and/or a vendor can select a widget 218 to interact with one or more market auctions. A restaurant operator and/or vendor, in on embodiment, can search for auctions on products, items, and/or services, view auctions details, and also sell items/products/services via an auction.

The restaurant operator and/or a vendor can view auction descriptions and submit bids for an auction via the interactive environment. The environment 112 can notify the restaurant operator and/or a vendor when he/she has been out-bid, has won an auction, or has lost an auction. If a user has won an auction and a payment service is to be used for completing the transaction, the interactive environment manager 125 can autonomously and without user intervention log into the payment service on behalf of the restaurant operator and/or a vendor. For example, the restaurant operator and/or a vendor can enter payment service account information (e.g., log-in and password information) when an account with the interactive environment 112 is setup. The interactive manager 125 uses this information to log into the payment service's website/application and any information required so that the restaurant operator and/or a vendor can pay for the auction item that has been won.

It should be noted that the above discussion with respect to the various options presented to customers in the interactive environment 112 is only one example of the interactive environment 112. Additional features/options can be added and/or deleted to/from the interactive environment 112. Also, similar features/options can be provided to vendors while interacting with the environment 112 so that the vendors can create/manage accounts, manage ad campaigns, and the like.

Managing Customer Orders Through the Interactive Environment

As discussed above, the interactive environment 112 enables a restaurant operator or other customer type to place orders for products/items offered by multiple vendors through a single interface. The following is a more detailed discussion on this process. In one embodiment, a user can instruct the interactive environment 112 to display one or more order guides to initiate the order process. A restaurant operator can utilize the order guides for placing an order through the interactive environment. An order guide, in one embodiment, is an established order template that the restaurant operator has setup at one or more food purveyors. For example, restaurant operators generally order the same items every day, week, month, and/or year. Therefore, the restaurant operator sets up an order guide at each food purveyor so that he/she does not have to enter the same information for repeated orders. Information in an order guide can include (but is not limited to) the purveyor name, product category/sub-category, product name and/or description, product package size, product brand, bar code or UPC information, pricing information, and the like.

The information retrieval manager 128 uses the operator's purveyor account information to obtain the order guide data. For example, the information retrieval manager 128, either dynamically (e.g., when the restaurant operator requests to place an order) or at a scheduled retrieval time acts as an agent on behalf of the operator and logs into the purveyor's website/application. The information retrieval manager 128 uses the operator's account information for the purveyor that is stored in the customer database 116. As discussed above, the user submits this information to the interactive environment during the account setup procedure. However, this information can also be entered at any time by the operator.

The information retrieval manager 128 interacts with the purveyor's website/application as if the restaurant operator is entering the required information. The information retrieval manager 128 selects the appropriate links/widgets/menus and/or submits the appropriate information to obtain the required order guides for the restaurant operator. The information retrieval manager 128 then stores this information in the customer database 116 as customer information 118 for that particular restaurant operator.

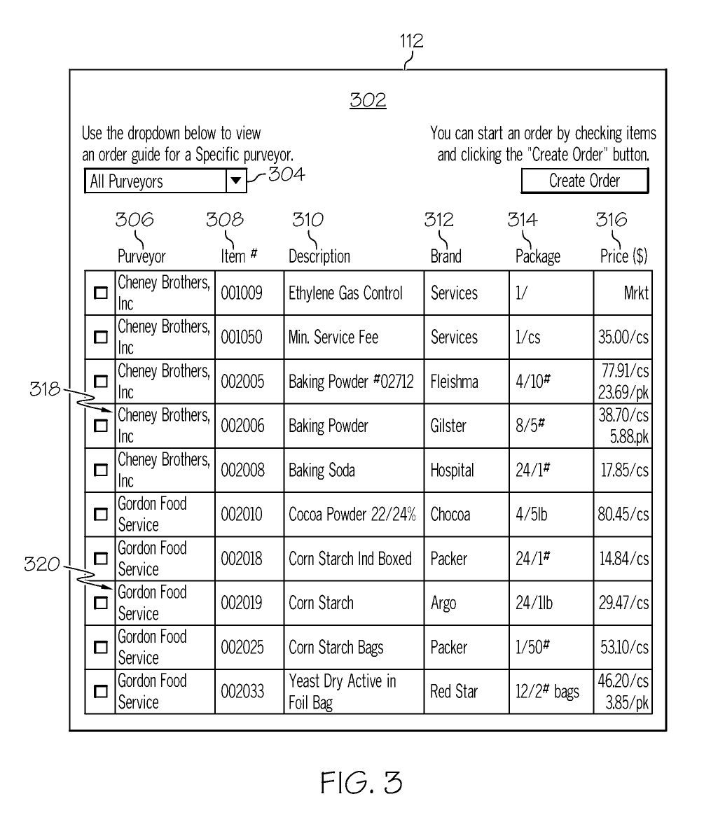

The order guide information can then be displayed to the restaurant operator. For example, FIG. 3 shows one example, of the interactive environment 112 presenting order guide information to a restaurant operator. In particular, FIG. 3 shows the interactive environment 112 presenting order guide information 302 for a plurality of purveyors, Cheney Brothers, Inc. and Gordon Food Service. As discussed above, this information was retrieved from the website/application of the food purveyors by an automated agent using the restaurant operator's food purveyor account information.

The order guide information 302 can be organized in any manner. For example, a default organization scheme can be to group data by food purveyor. However, the interactive environment 112 enables the restaurant operator to organize the data in various ways such as by food purveyor, item number, description, item name, brand, packaging, price, and the like. FIG. 3 shows a drop-down box 304 that provides the various organization methods, but any input method can be used. The restaurant operator can also input/select one or more locations to view the order guides associated with those locations. For example, FIG. 3 shows that a current location of Plantation, Fla. has been selected. Therefore, the order guide information 302 that is being displayed is for the Plantation, Fla. location.

As can be seen from FIG. 3, information such as purveyor 306, item number 308, item description/name 310, item brand 312, packaging information 314, and price 316 are displayed to the restaurant operator. The information retrieval manager 128, in one embodiment, ensures that the displayed information is not stale (e.g., out-of-date information) by accessing the purveyor's website application using the operator's account information, as discussed above, and verifies if the information has changed. For example, the information retrieval manager 128 checks the current price of a displayed item at the purveyor to determine if the pricing information for an item has changed. If any of the information has changed, the old information is updated accordingly. Also, the information retrieval manager 128 can visually and/or audibly notify the restaurant operator of an information update. For example, old pricing information can be displaying with the new pricing information being highlighted. It should be note that any visual and/or audible notification mechanism can be used. Also, the information retrieval manager 128 ensures that the items being displayed are still available at the given purveyor by logging into the purveyor and verifying that the displayed items are still available at the purveyor. The information retrieval manager 128 can perform the staleness and availability checks at scheduled intervals, in response to the information 302 being displayed to the operator, an operator selecting one or more items to begin an order, and/or an operator submitting an order.

The restaurant operator can also add or delete columns so that more or less information is shown. For example, the restaurant operator can instruct the interactive environment 112 to not show “item brand” 312 information but add a column displaying nutritional information. These preferences can also be saved as customer information 118 for subsequent presentations of order guide information to the restaurant operator.

The restaurant operator is also able to select one or more of the displayed rows/items to begin an order. For example, the restaurant operator can select the fourth row 318, which is for baking soda provided by Cheney Brothers, Inc. and the eighth row 320, which is for corn starch provided by Gordon Food Service. By displaying product information from a plurality of food purveyors at a single interface, the restaurant operator can compare prices and products. The user can then select to order these items from the different purveyors in a single transaction.

Additionally, a restaurant operator can manage item units for the order guides and orders. For example, FIG. 3 shows that various units of measure forms are used under the “Package” column 314. One purveyor may use one form of a unit of measure while another purveyor may use another form of the same unit of measure. Also, a single purveyor may use multiple forms of a unit of measure as well. The interactive environment manager 125 can standardize these units of measurement forms so that the same form or unit of measurement is displayed. For example, one purveyor may show that a package size is “ 2/6#” while another purveyor shows that the package size is “2@6 lbs”. Each of these package sizes are displaying the unit of measurement in pounds but in different forms such as “#” and “lbs”. Another purveyor may use kilograms instead of pounds. Therefore, in one embodiment, the restaurant operator can instruct the interactive environment to always display units of measurement in pound using the form “lbs”. In this embodiment, the interactive environment manager 125 converts all forms of the pound unit of measurement into “lbs” and converts other weight measurements such as kilograms into pounds.

In another example, a food purveyor such as Cheney Brothers has a sweet chocolate powder item with a package size displayed as “ 2/6#”. Sysco has a comparable sweet chocolate powder item with a package size displayed as “ 2/6 lbs”. Therefore, the interactive environment manager 125 calculates the total units as 12 Lb. For example, the interactive environment manager 125 converts the known measurement identifiers for pounds (e.g., #, lbs, LBS, etc.) to a standard measurement such as “Lb”. The number of units within a package such as 2 in the current example is multiplied by the unit measurement, which is 6 in this example. Therefore, the interactive environment manager 125 calculates the total units as 12 Lb. The following are examples of standardized measurements:

### US Measurements:

Volume
Fluid Ounce displayed as “FL OZ”
Pint displayed as “PT”
Quart displayed as “QT”
Gallon displayed as “GAL”

Weight
Ounce displayed as “OZ”
Pound displayed as “LB”

Length
Inches displayed as “IN”
Feet displayed as “FT”
Yards displayed as “YD”

### Metric Measurements:

Volume
Milliliter displayed as “ML”
Liter displayed as “L”

Weight
Milligram displayed as “MG”
Gram displayed as “G”
Kilogram displayed as “KG”

Length
Millimeter displayed as “MM”
Centimeter displayed as “CM”
Meter displayed as “M”

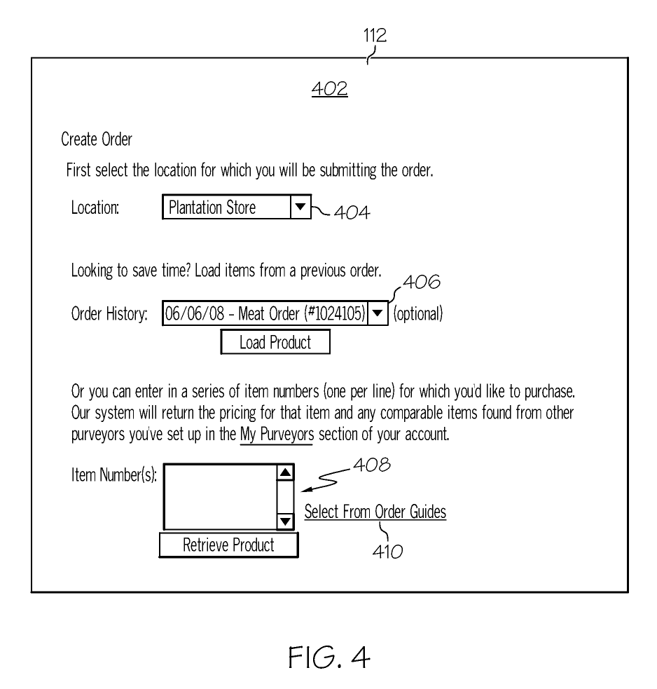

FIG. 4 shows another example of how a restaurant operator can initiate the order process. In particular, FIG. 4 shows the interactive environment 112 displaying a create order form 402. This form 402 enables a restaurant operator to select one or more locations via a drop-down box 404. It should be noted that the present invention is not limited to a drop-down box and any input method can be used. An “order history” prompt 406 enables the restaurant operator to load previous orders that have been submitted either through the interactive environment and/or one or more food purveyors' website/application. The order histories have been discussed in greater detail above. Also, an area 408 of the order form 402 enables the restaurant operator to add specific items numbers so that an order can be generate there from. The operator is also present with the option of selecting items from the order guides 302 discussed above (as shown by the link 410). If the operator selects the option to choose items from an order guide 302, the user can select one or more items from the guide 302 as discussed above and the order form 402 is then populated with the selected items.

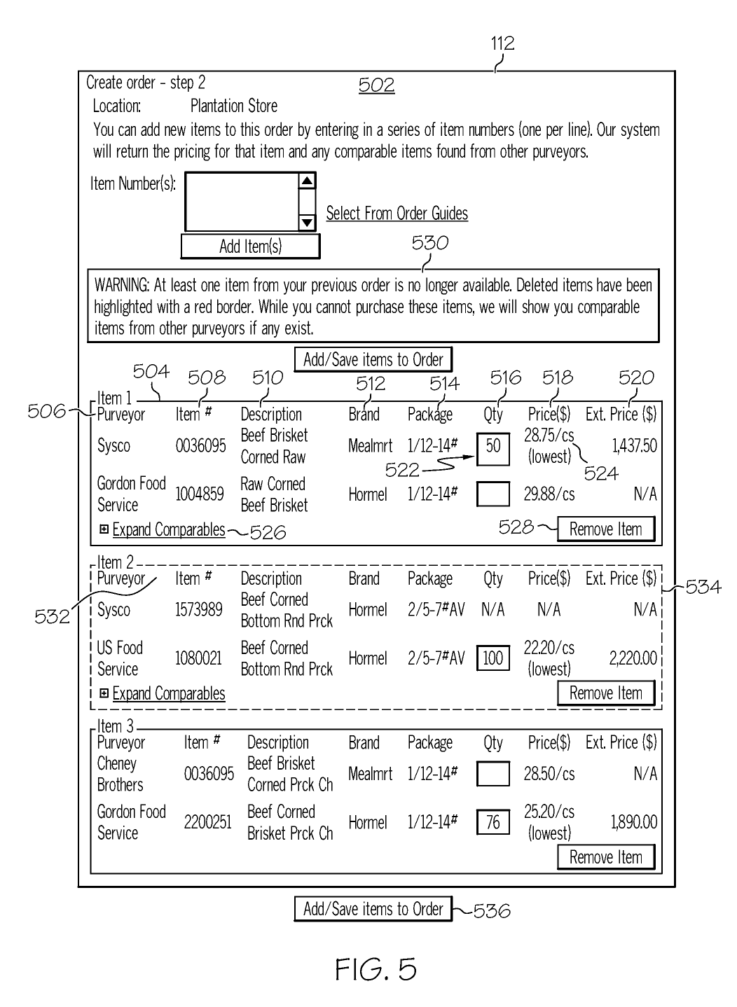

Once the restaurant operator has manually entered item numbers, selected items from an order guide, and/or loaded items from order histories into the create order form 402, a more detailed order form 502 is displayed to the operator, as shown in FIG. 5. The order form 502 shown in FIG. 5 displays the items selected by the operator to be included in the order and any comparable items. A comparable item is a product/item that is offered by another food purveyor other than the purveyor offering the item selected by the operator that is similar to the selected item.

For example, FIG. 5 shows Item_1 504 selected by the restaurant operator is a beef brisket offered by the food purveyor Sysco. A comparable beef brisket from the food purveyor Gordon Food Service is shown to the operator so that the operator can compare prices, packaging, and the like. This enables the restaurant operator to identify the best deal and save money. A restaurant operator, in one embodiment, can manually load comparable information into the interactive environment 112. For example, the operator can select a specific purveyor such as Sysco. The interactive environment 112 can then present the operator with a list of all products/items offered by Sysco or items that are located within an operator's order guide 302. The operator can then select a product from the list such as beef brisket and add comparable product/item information for other food purveyors.

For example, the restaurant operator can enter a comparable item such as beef brisket from Gordon Food Service. Information such as the food purveyor offering the comparable item, item number, item description, and the like can be entered. Therefore, when the detailed order form 502 is shown to the operator, comparable product information is displayed to the user as shown in FIG. 5. A restaurant operator can also upload one or more files comprising comparable product information to the interactive environment 112. If the user has entered a comparable item that the interactive environment 112 cannot find at the associated food purveyor, the environment 112 can notify the restaurant operator accordingly. It should be noted that the operator is not required to enter all information associated with a comparable product that is displayed to the operator. For example, the user can enter only the item number information for a comparable product and the information retrieval manager 128 retrieves the additional information such as food purveyor, item description, item pricing, and the like.

In another embodiment, the interactive environment 112 autonomously displays comparable products to the restaurant operator. For example, the information retrieval manager 128 analyzes each item in the current order form that the user has entered/selected. The information retrieval manager 128 then identifies comparable products/item from either the same purveyor as a currently selected item and/or from other food purveyors. The information retrieval manager 128 can compare items numbers, descriptions, brand, packaging, and other information to determine products that are substantially similar to items currently in the order form 502. Also, the information retrieval manager 128 can utilize previous comparable information entered by the restaurant operator and/or other operators. For example, restaurant operators can identify comparable products as discussed above. The information retrieval manager 128 can use this information from the current operator and/or other operators to automatically identify and display comparable products to the restaurant operator.

In one embodiment, the information retrieval manager 128 utilizes a set of abbreviations and/or synonyms when identifying comparable products. The set of abbreviations and/or synonyms can be part of the item information 126 within the item database 126 or can be maintained in a separate database (not shown) as well. When using abbreviations and/or synonyms to identify comparable products/items the information retrieval manager 128 identifies an items number(s), description, brand, packaging information such as size and quantity, and other information of a product and identifies abbreviations and/or synonyms for the retrieved product information. Therefore, when the information retrieval manager 128 searches for comparable products the information retrieval manager 128 not only searches for products with product information exactly matching the given item's product information but searches for products associated with product information matching any abbreviations and/or synonyms of the given item's product information.

For example, a given product's packaging information can state “5 pounds”. The information retrieval manager 128 searches the product abbreviation/synonym database for abbreviations/synonyms associated with “5” and “pounds”. This search yields an abbreviation of “pounds” as “lbs”, “LBS”, “Lbs” and a synonym of “5” as “five”. Therefore, the information retrieval manager 128 not only searches for comparable products comprising product information of “5 pounds”, but also searches for products with product information comprising any of the related abbreviations and/or synonyms such as “5 lbs”, “five pounds”, etc. It should be noted that the information retrieval manager 128 can also convert units of measure as well to find comparable products. For example, the information retrieval manager 128 can not only search for products with a packaging size of “5 pounds” but also for “2.27 kg” as well. These features of the information retrieval manager 128 are advantageous because a simple text comparison method may miss items that are comparable but that have different units of measure, abbreviations, synonyms, and the like.

With respect to the order form 502, the interactive environment 112 displays each item placed into the order form 502 by the user and any comparable items, as discussed above. For each item, the interactive environment 112 shows the user Purveyor 506, Item Number 508, Item Description 510, Brand Name 512, Packaging 514, Quantity 516, Price 518, and Extended Price 520 information. Unit price information can also be displayed (not shown). Unit price is the price of an item per unit. For example, if a package comprises 2 items, the Unit price is cost of one item within the package. The restaurant operator is able to enter a specific quantity for each of the items as shown by the quantity box 522. Alternatively, the quantity box 522 can be automatically filled in by the interactive environment manager 125 based on previous orders made by the operator.

The interactive environment 112, in one embodiment, also visually and/or audibly notifies the operator as to which item or comparable item in an item group has the lowest price. For example. FIG. 5 shows that the interactive environment 112 has notified the operator that the beef brisket from Sysco has a lower price than the comparable beef brisket from Gordon Food Service by visually changing the price display 524 and adding the text “(lowest)”. It should be noted that any visual and/or audible notification mechanism can be used to indicate to the user which item has the lowest price and/or is the best deal.

The number of comparable items that are displayed for each item group can be predefined. For example, the interactive environment 112 may only show a comparable item that best matches the item entered by the user. Therefore, the operator can instruct the environment 112 to display additional comparable items. For example, FIG. 5 shows a clickable link 526 that a user can select to have additional comparable products displayed. It should be noted that the present invention is not limited to a clickable link for displaying additional comparable products.

The order form 502 can also include a “remove item” function 528 that allows a user to remove an item from the order. For example, each item group such as item group 504 can include this function 528 that when selected removes the item 504 from the order. Also, a user may enter or select an item when creating an order as discussed above with respect to FIG. that may not longer be available from the purveyor. In this situation, the interactive environment 112 can notify the restaurant operator that the item cannot be found at the purveyor.

FIG. 5 illustrates a user interface of one example of notifying the operator by displaying a message 530 to the user. Also, an area of the environment 112 where the item was to be displayed can also be visually altered to indicate to the operator that the item cannot be found. For example, FIG. 5 shows that area for Item_2 532 has been visually altered as shown by the dashed box 534. If an item cannot be found, the interactive environment 112 can display comparable items from the same purveyor as the missing item and/or other purveyors as well. The interactive environment 112 can notify the operator that comparable items have been displayed in a message 520, by highlighting the comparable items, and/or or by any other visual (and/or) audible notification mechanisms.

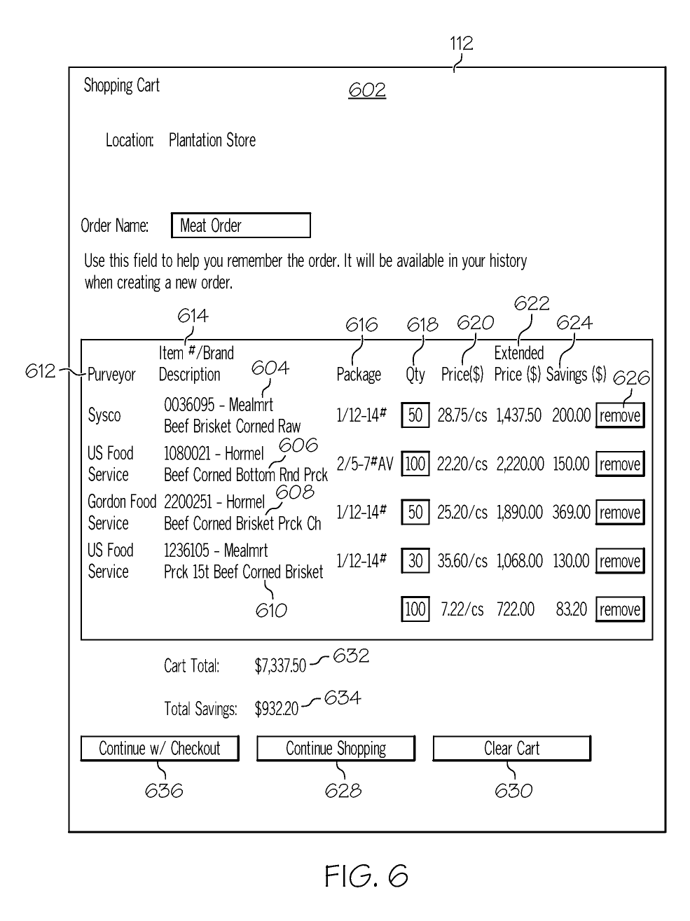

Once the restaurant operator has selected the desired items from each of the item groups 504, 532, the operator can save the order. For example, the operator can select a save widget 536. The restaurant operator is then presented with a “shopping cart” 602 of items corresponding to the current order, as shown in FIG. 6. In particular, FIG. 6 shows the current order of the restaurant operator and displays each item within the order. For example, FIG. 6 shows four different items in the order, a raw beef brisket 604, beef corned bottom 606, a pre-cooked beef brisket 608, and another variety of beef brisket 610. The order summary/shopping cart 602 also displays Purveyor 612, Item number/Brand/Description 614, Package 616, Quantity 618, Price, 620, Extended Price 622, and Savings 624 information.

As can be seen, the restaurant operator has added items to the order that are from different purveyors. As discussed above, conventionally, the operator would have had to separately log into each of the different food purveyors' websites/applications to place an order through each particular purveyor. However, the restaurant operator according to the various embodiments of the present invention can place an order for items from the different purveyors at a single centralized location.

The order summary/shopping cart 602 also allows a user to remove any of the items in the order by selecting, for example, a “remove” widget 626. The operator can also add additional items to the order by selecting, for example, a “continue shopping” widget 628. The entire contents of the order can also be cleared by, for example, selecting a “clear content” widget 630. It should be noted that these widgets 626, 628, 630 and their associated functions are only examples and can be implemented in more than one way.

The order summary/shopping cart 602 can also display the order total 632 and/or a total savings amount 634. When the restaurant operator has finished with the order summary/shopping cart 602 the operator can submit the order for processing. For example, the operator can select a submit widget 636. In one embodiment, when the operator submits the order the interactive environment manager 125 analyzes the pricing information in the order to ensure that the pricing information for the items has not changed. In one embodiment, the interactive environment manager 125 determines when the pricing information associated with the order was retrieved from the associated purveyor.

If time period from when the pricing information was retrieved is greater than a given threshold, the interactive environment manager 125 logs into the purveyors' websites/applications using the operator's account information, as discussed above, to obtain new pricing information. If the time period is below a given threshold the interactive environment manager 125 does not obtain new pricing information. Alternatively, the interactive environment manager 125 obtains new pricing information every time the operator submits an order regardless of when the original pricing information was retrieved.

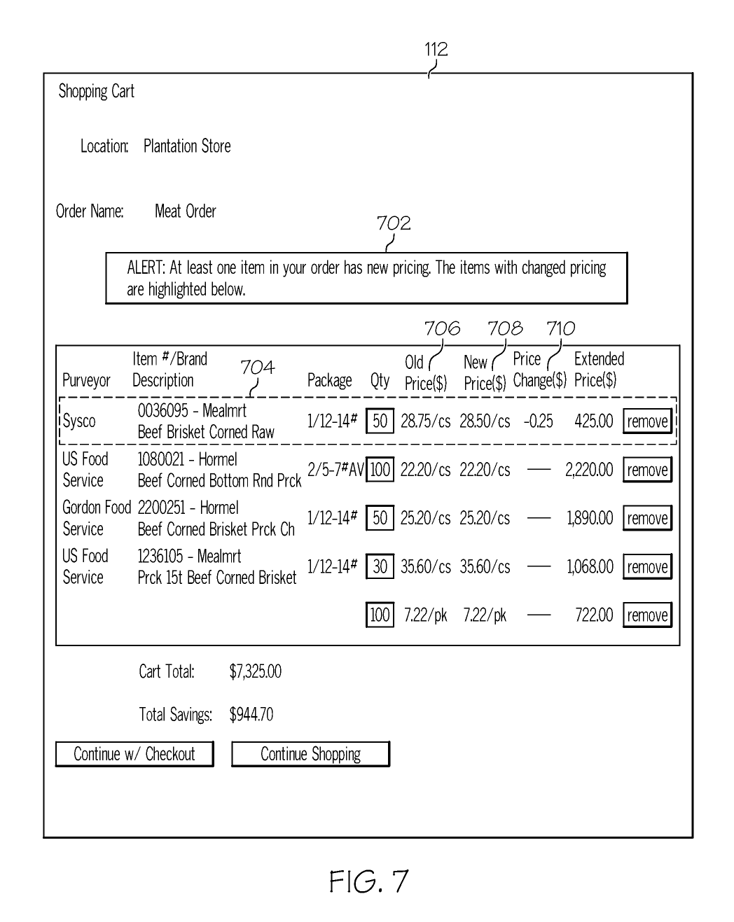

If the pricing information has changed, the interactive environment 112 notifies the operator. For example, FIG. 7 shows that the interactive environment 112 has displayed a message 702 to the operator that indicates that at least one item in the order has new pricing. The item with the pricing change is also visually altered in FIG. 7, as shown by the dashed box 704, so that the restaurant operator can easily identify the item. In particular, the interactive environment 112 displays an order summary similar to the summary discussed above with respect to FIG. 6. However, FIG. 7 also shows that an “Old Price” column 706, a “New Price” column 708, and a “Price Change” column 710 have been added. The “Old Price” column 706 displays the pricing of the item prior to a pricing change. The “New Price” column 708 displays the pricing of the item after a pricing change. The “Price Change” column 710 displays the change in price. For example, FIG. 7 shows that for the Sysco beef brisket the old pricing was $28.75/cs and the new price is $28.50/cs with a price change of −$0.25. The user can then decide to remove any items, add items, or continue with the checkout process as discussed above.

In one embodiment, when the operator submits the order the interactive environment manager 125 analyzes the pricing information in the order to ensure that the pricing information for the items has not changed. In one embodiment, the interactive environment manager 125 determines when the pricing information associated with the order was retrieved from the associated purveyor.

If time period from when the pricing information was retrieved is greater than a given threshold, the interactive environment manager 125 logs into the purveyors' websites/applications using the operator's account information, as discussed above, to obtain new pricing information. If the time period is below a given threshold the interactive environment manager 125 does not obtain new pricing information. Alternatively, the interactive environment manager 125 obtains new pricing information every time the operator submits an order regardless of when the original pricing information was retrieved.

In addition to ensuring that the interactive environment has the most update pricing information available, interactive environment manager 125 also ensures that the products/items within the restaurant operator's order are still available at the respective purveyor. In one embodiment, the interactive environment manager 125 determines when the availability of the products/items associated with the order was last verified at the associated purveyor.

If time period from when the availability was verified is greater than a given threshold, the interactive environment manager 125 logs into the purveyors' websites/applications using the operator's account information, as discussed above, to verify product/item availability. If the time period is below a given threshold the interactive environment manager 125 does not verify product/item availability. Alternatively, the interactive environment manager 125 verifies product/item availability every time the operator submits an order regardless of when the availability of the products/items was last verified. If a product/item is no longer available at a food purveyor the interactive environment manager 125 can visually and/or audibly notify the operator similar to the embodiment discussed above with respect to pricing information notification.

If a product/item is no longer available at a food purveyor the interactive environment manager 125 allow the operator to change his/her order. The interactive environment manager 125, in one embodiment, also displays comparable products to the product that is no longer available and/or displays additional purveyors that do have the item/product available. The operator can then modify his/her order accordingly.

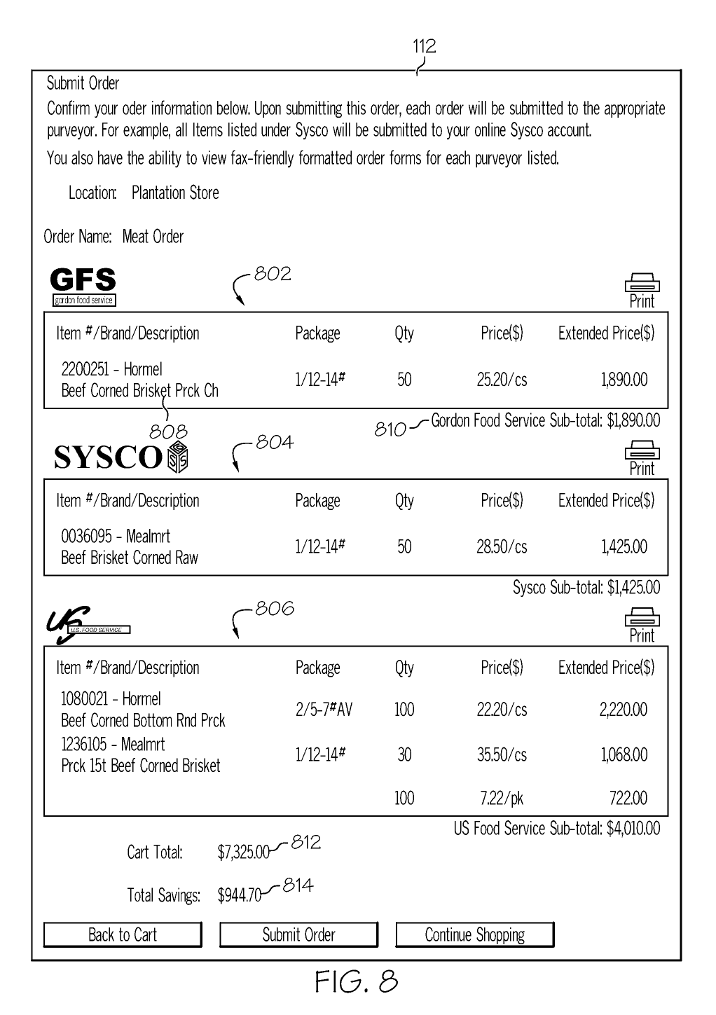

If pricing information has not changed; the user submits the order for processing after pricing information has changed; all products are available; and/or the user submits the order for processing after modifying the order in response to one or more products not being available, the interactive environment 112, in one embodiment, displays each food purveyor to the user and each item being order from the food purveyors. For example, FIG. 8 shows that the user has ordered from Gordon Food Service, Sysco, and US FoodService. Each food purveyor group 802, 804, 806 includes the items 808 ordered from the food purveyor 802 and information associated with the item (which has been discussed above). The interactive environment 112 also displays a sub-total 810 for each food purveyor 802, a cart total 812, and a total savings amount 814.

The restaurant operator can then submit his/her order for final processing. The interactive environment manager 125 then automatically logs into each of the food purveyor's websites that are associated with the order to place an order for the items listed in the order submitted by the operator. For example, the interactive environment manager 125 logs into Gordon Food Service's website on behalf of the restaurant operator using the Gordon Food Service account information provided by the user. The interactive environment manager 125 places an order through the Gordon Food Service's website just as if the operator was placing the order his/herself.

As can be seen from the above discussion, restaurant operators are able to place orders for items offered by different vendors at a centralized location. The interactive environment 112 autonomously and without user intervention is able to log into the various food purveyors' websites/applications on behalf of the operator and place an order. A restaurant operator no longer is required to separately log into each purveyor's website/application to place an order.

In addition to the above embodiments, a restaurant operator can also load recipe information into the interactive environment 112 for pricing analysis. Recipe information can be added to the operator's interactive environment account as customer information 118 during the interactive account setup process discussed above or any time thereafter. The server 104 can also store recipe information in a separate database as well. Also, the restaurant operator can directly type recipe information into the interactive environment 112 as compared to uploading a file. The recipe information, in one embodiment, is parsed by the interactive environment manager 125 to perform one or more price/cost analysis operations. The recipe price/cost analysis allows an operator to determine the cost of a recipe and see if the prices of the ingredients are increasing, decreasing, or staying the same. Therefore, a restaurant operator can decide whether or not to increase menu prices. However it is important to note, that the present invention for the first time allows the restaurant to track exact food prices during each order process. This provides an important competitive advantage. In the past, whenever a restaurant was faced with increasing food prices, restaurants would purchase cheaper ingredients and/or reduce portion size. By using the present invention, the restaurant can track costs of each recipe. Consistency of ingredients and portion size is very important for many restaurants and restaurant chains.

Moreover, in another embodiment, the present invention keeps track of the restaurant's local inventory in customer database 116. Keeping track of local inventory is important for recipe pricing. For example, if a recipe requires an ingredient that the restaurant currently has in stock, then the price of the recipe for this ingredient will not change. This permits the restaurant to make decisions regarding the price of recipes based on current inventory as well.

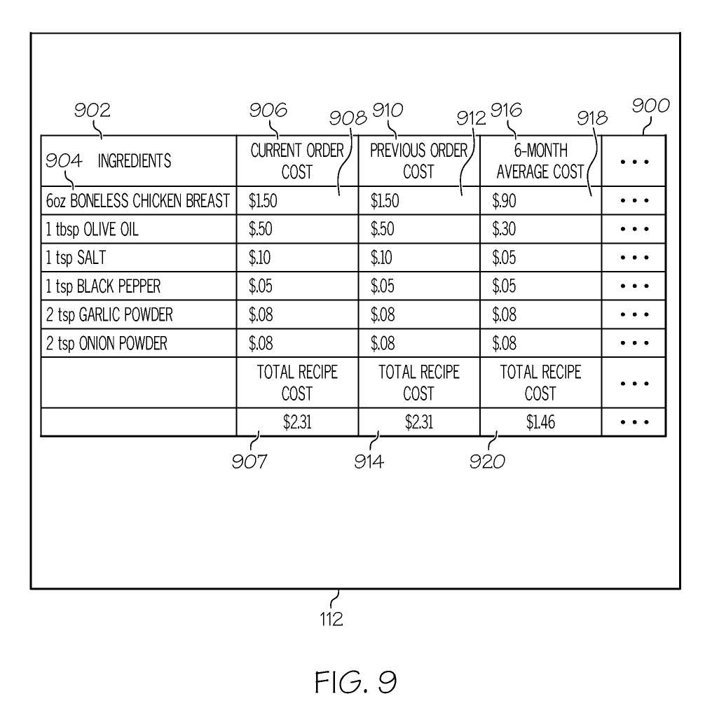

For example, FIG. 9 illustrates a user interface of one example of the interactive environment 112 displaying a recipe associated with a restaurant and a cost analysis of each ingredient within the recipe. The recipe cost analysis process can be initiated by interacting with a stand alone widget (or menu) on a main page of the environment 112 such as those discussed above with respect to FIG. 2; interacting with a widget within a sub-page such as an order page; interacting with a menu of a sub-page within the environment 112; and/or the like.

In particular, FIG. 9 shows a table 900 within the interactive environment 112 comprising a first column 902 labeled “Ingredients”. The “Ingredients” column 902 comprises entries that include ingredients and ingredient quantities of a given recipe. For example, a first entry 904 under the “Ingredients” column 902 includes “6 oz Boneless Chicken Breast”. The table 900 also includes a second column 906 labeled “Current Order Cost”. The “Current Order Cost” column 906 comprises entries that indicate the current cost of an ingredient based on a current order. For example, a first entry 908 under the “Current Order Cost” column 906 shows that the current cost of a 6oz Boneless Chicken Breast is $1.50 based on the operator's current order. The “Current Order Cost” column 906 also includes a “Total Recipe Cost” entry 907 that displays the final cost of the recipe based on the current order. For example, FIG. 9 shows that the Total Recipe Cost for the current order is $2.31. The current order Total Recipe Cost is calculated by adding all of the ingredient costs together under the “Current Order Cost” column 906.

The table 900 further includes a third column 910 labeled “Previous Order Cost”. The “Previous Order Cost” column 910 comprises entries that display the cost of a recipe ingredient based on the last order placed prior to the current order. For example, a first entry 912 under the “Previous Order Cost” column 910 shows that cost of a 6 oz Boneless Chicken Breast based on the previous order was $2.31. The “Previous Order Cost” column 910 also includes a “Total Recipe Cost” entry 914 that displays the final cost of the recipe based on the previous order. For example, FIG. 9 shows that the Total Recipe Cost for the previous order is $2.31. The previous order Total Recipe Cost is calculated by adding all of the ingredient costs together under the “Previous Order Cost” column 910.

The table 900 also includes a fourth column 916 labeled “6-month Average Cost”. The “6-month Average Cost” column 916 comprises entries that display the average cost of a recipe ingredient over a 6-month time period. It should be noted that any given time period can be chosen either by the interactive environment manager 125 and/or the restaurant operator. A 6-month time period is only being shown as one example. For example, a first entry 918 under the “6-month Average Cost” column 916 shows that the 6-month average cost for a 6oz Boneless Chicken Breast is $0.90. The “6-month Average Cost” column 916 also includes a “Total Recipe Cost” entry 920 that displays a 6-month average final cost of the recipe. For example, FIG. 9 shows that the 6-month average Total Recipe Cost for the recipe is $1.46. The 6-month average Total Recipe Co is calculated by adding all of the ingredient costs together under the “6-month Average Cost” column 910. It should be noted that the columns and entries displayed in the table 900 are only illustrative and one or more of the displayed columns/entries can be deleted and/or one or more additional columns/entries can be added.

As can be seen, displaying the costs of recipe ingredients to a restaurant operator has many advantages. For example, a restaurant operator can determine the total cost of a recipe. The operator can also see pricing changes for ingredients over given time periods. This allows the operator to determine if menu changes are needed to reflect the increases/decreases in ingredient costs.

In one embodiment, the information retrieval manager 128 calculates the Current Order Cost (and Previous Order Cost) for each ingredient as follows. The information retrieval manager 128 analyzes the operator's current or most recent order and identifies products/items in the order that match the ingredients of the given recipe. For example, the information retrieval manager 128 searches the current order for boneless chicken breast, olive oil, salt, black pepper, garlic powder, and onion powder. If the information retrieval manager 128 is unable to locate any recipe items in the current order, the information retrieval manager 128 searches each previous order until the item is located. The operator can also be visually and/or audibly notified when an item in the recipe is not in the current or most recent order and another order was used to obtain the cost information.

Once the information retrieval manager 128 has located an ingredient within the order the information retrieval manager 128 performs any unit conversions that are necessary. For example, if the order includes 1 gallon of olive oil and the recipe requires a tablespoon unit of measure, the information retrieval manager 128 converts gallons into tablespoons. For example, the information retrieval manager 128 converts 1 gallon into 256 tablespoons. The information retrieval manager 128 then determines the recipe ingredient cost. For example, if the order was for 1 gallon of olive oil at $128, the information retrieval manager 128 calculates the following: 1 gallon=256 tablespoon, therefore $128/256=$0.50 per tablespoon.

In one embodiment, the information retrieval manager 128 calculates an Average Order Cost for each ingredient as follows. The information retrieval manager 128 analyzes the operator's orders over a given time period such as 6 months. If an operator places an order every month the information retrieval manager 128 analyzes 6 orders. The information retrieval manager 128 then identifies products/items in the orders that match the ingredients of the given recipe. For example, the information retrieval manager 128 searches the 6 orders for boneless chicken breast, olive oil, salt, black pepper, garlic powder, and onion powder. If the information retrieval manager 128 is unable to locate any recipe items in the orders or can only locate the items in some of the orders, the information retrieval manager 128 searches additional orders until the item is located or an average can be calculated. The operator can also be visually and/or audibly notified when an item in the recipe is not any order within the given time period of if the information retrieval manager 128 had to go beyond the given time period to obtain cost information.

Once the information retrieval manager 128 has located the ingredients within orders the information retrieval manager 128 performs any unit conversions that are necessary, as discussed above. The information retrieval manager 128 then averages the costs of each item and displays the average cost to the user. For example, if the cost of a 6 oz boneless chicken breast over 6 months was $1.00, $1.25, $0.90, $0.90, $0.675, $0.675 then the 6 month average is $1.00+$1.25+$0.90+$0.90+$0.675+$0.675=$5.40/6=$0.90.

Example Process of Placing an Order for a User

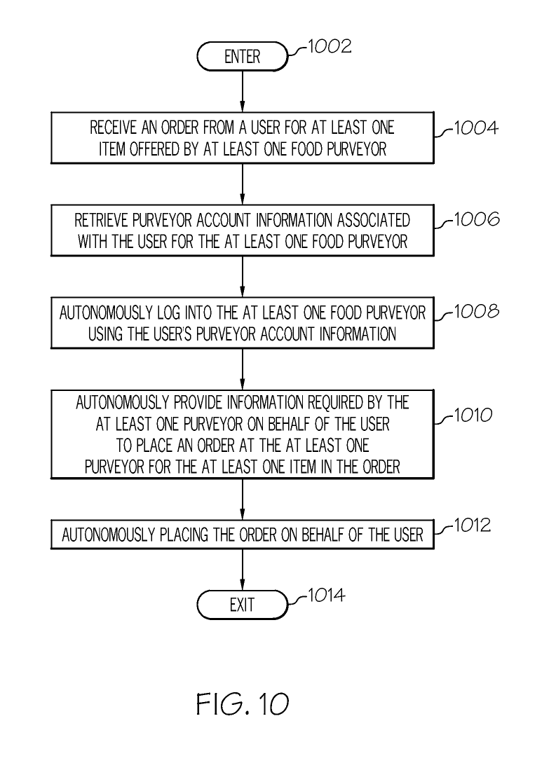

FIG. 10 is an operational flow diagram illustrating one example of placing an order for a user such as a restaurant operator at one or more food purveyors. The operational flow diagram of FIG. 10 begins at step 1002 and flows directly into step 1004. The interactive environment 112, at step 1004, receives an order from a user for at least one item offered by at least one food purveyor. The process of a user selecting one or more items for an order has been discussed above with respect to FIGS. 3-7.

The interactive environment 112, at step 1006, retrieves purveyor account information associated with the user for the at least one food purveyor. For example, the interactive environment 112 can retrieve the purveyor website login/password information that the user entered when he/she setup during his/her interactive environment 112 account. Alternatively, the interactive environment 112 can dynamically prompt the user to enter the required purveyor account information. The interactive environment 112, at step 1008, autonomously and without user intervention logs into the at least one food purveyor's website/application using the user purveyor account information.

The interactive environment 112, at step 1010, autonomously and without user intervention provides information required by the at least one purveyor on behalf of the user to place an order at the purveyor. For example, the information retrieval manager 128 of the interactive environment 112 selects prompts, enters information, and the like just as if the user himself/herself is placing an order at the food purveyor. The interactive environment 112, at step 1012, then places the order on behalf of the user. The control flow then exits at step 1014.

Another Example Process of Placing an Order for a User

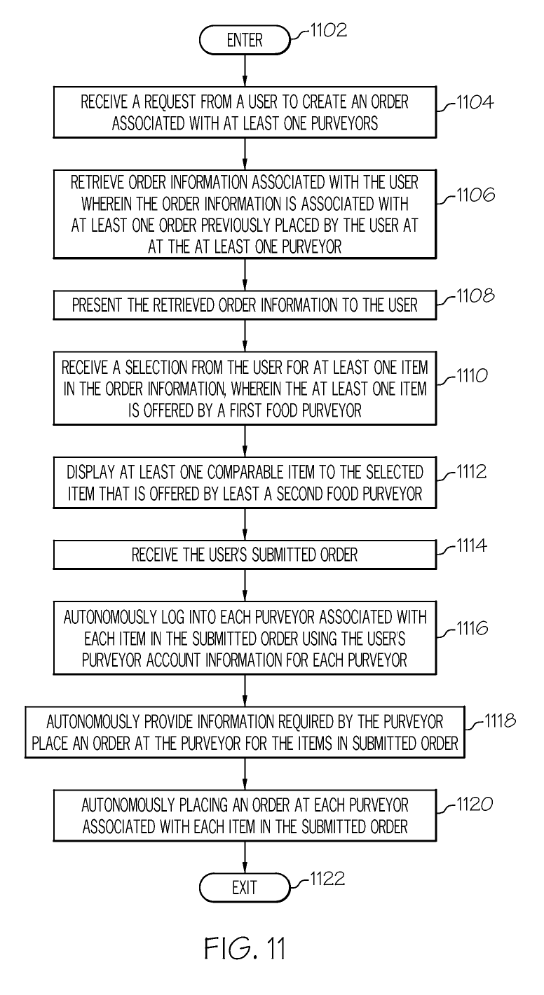

FIG. 11 is an operational flow diagram illustrating another example of placing an order for a user such as a restaurant operator at one or more food purveyors. The operational flow diagram of FIG. 11 begins at step 1102 and flows directly into step 1104. The interactive environment 112, at step 1104, receives a request from a user to create an order associated with at least one food purveyor. The interactive environment 112, at step 1106, retrieves order information associated with the user. This order information is associated with at least one order that was previously placed by the user at the purveyor. For example, the order information can be one or more order guides 302 or order histories. The interactive environment 112, at step 1108, presents the retrieved order information to the user. Order guides and order histories and the presentment thereof have been discussed above with respect to FIGS. 2-4.

The interactive environment 112, at step 1110, receives a selection/input from the user for at least one item in the order information. For example, the user can select a beef brisket item that is offered by Sysco. In response to the user selecting an item, the interactive environment 112, at step 1112, displays at least one comparable item to the selected item that is offered by the same or different purveyor(s). Comparable items have been discussed above with respect to FIG. 5. The interactive environment 112, at step, 1114, receives the order submitted by the user that can include the originally selected items and/or comparable items.

The interactive environment 112, at step 1116, autonomously and without user intervention logs into each food purveyor's website/application associated with an item in the order using the user purveyor account information discussed above. The interactive environment 112, at step 1118 autonomously and without user intervention provides information required by a purveyor on behalf of the user to place an order at the purveyor. The interactive environment 112, at step 1120, then places an order on behalf of the user at each of the purveyors offering an item in the order. The control flow then exits at step 1122.

Example Process of Managing a User Order

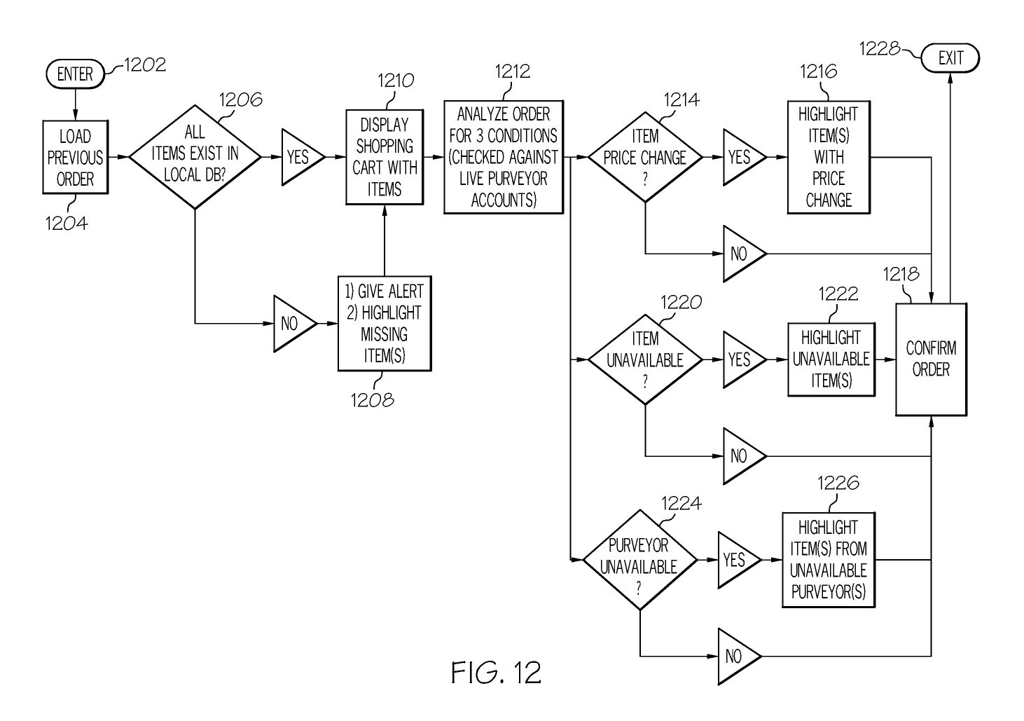

FIG. 12 is an operational flow diagram illustrating an example of managing an order from a user for one or more item offered by one or more food purveyors. The operational flow diagram of FIG. 12 begins at step 1202 and flows directly into step 1204. The interactive environment 112, at step 1204, determines that a user is requesting to create an order and retrieves a previous order associated with the user. For example, because restaurant operators generally order the same items when placing an order every week, month, or year, using previous orders to create an order form for a user can save the user time. For example, the user does not have to create an order from scratch and can user a previous order as a template.

The interactive environment 112, at step 1206, determines if all the items in the order history are within the item database 124. If the result of this determination is negative, the interactive environment 112, at step 1208, notifies the user and missing items can be highlighted. This situation can occur if a particular purveyor associated with an item no longer carries the item. The interactive environment 112 can display a similar item to the user or can identify another purveyor that carries that same item. If the result of this determination is positive, the interactive environment 112, at step 1210, displays an order summary/shopping cart to the user. As discussed above, the user can modify the order to include more or less items.

The interactive environment 112, at step 1212, then analyzes the order/shopping cart to check for various conditions. For example, the interactive environment 112, at step 1214, determines if pricing information for any of the items in the order has changed. If the result of this determination is positive, the interactive environment 112, at step 1216, notifies the user of the pricing change. The control then flows to step 1218 where the user confirms and submits the order for processing. If the result of this determination is negative, the control flows to step 1218.

The interactive environment 112, at step 1220, also determines if an item in the order is available. If the result of this determination is that the item is unavailable, the interactive environment 112, at step 1222, notifies the user. The control then flows to step 1218. If the result of this determination is that the items are available the control then flows to step 1218. The interactive environment 112, at step 1224, also determines if a purveyor associated with an item in the order is available. If the result of this determination is that a purveyor is unavailable, the interactive environment 112, at step 1226, notifies the user and also identifies the items in the order that are associated with the unavailable purveyor. The control then flows to step 1218. If the result of this determination is that the purveyors are available the control then flows to step 1218.

Example Process of Autonomously Retrieving User Information from a Purveyor

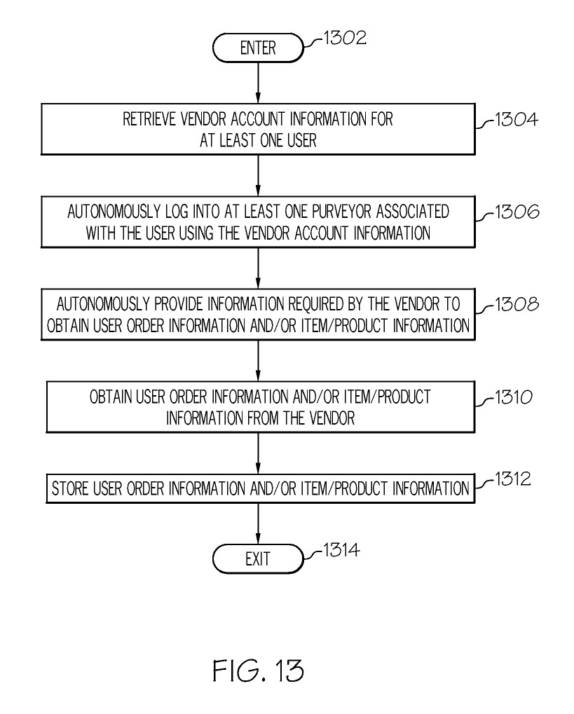

FIG. 13 is an operational flow diagram illustrating an example of autonomously retrieving user information from a purveyor. The operational flow diagram of FIG. 13 begins at step 1302 and flows directly into step 1304. The interactive environment 112, at step 1304, retrieves purveyor account information for at least one user from the customer database 116. The interactive environment 112, at step 1306, autonomously logs into at least one purveyor associated with the user using the user's purveyor account information.

The interactive environment 112, at step 1308, autonomously provides information required by the purveyor to obtain user order information and/or product/item information from the purveyor. The interactive environment 112, at step 1310, retrieves/receives user order information and/or product/item information from the purveyor. The interactive environment 112, at step 13112, stores the user order information and/or product/item information into one or more repositories 116, 124. The control flow then exits at step 1314.

Information Processing System

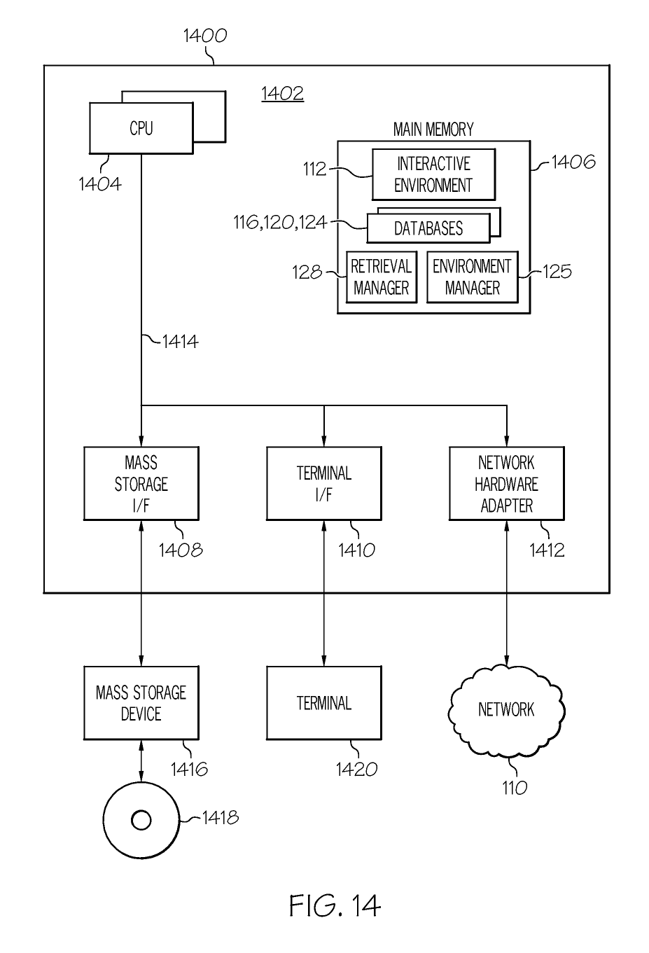

FIG. 14 is a block diagram illustrating a more detailed view of the information processing system 1400 according to one embodiment of the present invention. The information processing system 1400 is based upon a suitably configured processing system adapted to implement the exemplary embodiment of the present invention. Any suitably configured processing system is similarly able to be used as the information processing system 1402 by embodiments of the present invention such as an information processing system residing in the computing environment of FIG. 1, a personal computer, workstation, or the like.

The information processing system 1402 includes a computer 1402. The computer 1402 has a processor 1404 that is connected to a main memory 1406, mass storage interface 1408, terminal interface 1410, and network adapter hardware 1412. A system bus 1414 interconnects these system components. The mass storage interface 1408 is used to connect mass storage devices 1416 to the information processing system 1402. One specific type of data storage device is an optical drive such as a CD/DVD drive, which may be used to store data to and read data from a computer readable medium or storage product such as (but not limited to) a CD/DVD 1418. Another type of data storage device is a data storage device configured to support, for example, NTFS type file system operations.

The main memory 1406, in one embodiment, comprises the interactive environment 112, the databases 116, 120, 124, the information retrieval manager 128, and the interactive environment manager 125. Although illustrated as concurrently resident in the main memory 1406, it is clear that respective components of the main memory 1406 are not required to be completely resident in the main memory 1406 at all times or even at the same time. In one embodiment, the information processing system 1402 utilizes conventional virtual addressing mechanisms to allow programs to behave as if they have access to a large, single storage entity, referred to herein as a computer system memory, instead of access to multiple, smaller storage entities such as the main memory 1406 and data storage 1416. Note that the term “computer system memory” is used herein to generically refer to the entire virtual memory of the information processing system 1402.

Although only one CPU 1404 is illustrated for computer 1402, computer systems with multiple CPUs can be used equally effectively. Embodiments of the present invention further incorporate interfaces that each includes separate, fully programmed microprocessors that are used to off-load processing from the CPU 1404. Terminal interface 1410 is used to directly connect one or more terminals 14020 to computer 1402 to provide a user interface to the computer 1402. These terminals 14020, which are able to be non-intelligent or fully programmable workstations, are used to allow system administrators and users to communicate with the information processing system 1402. The terminal 1420 is also able to consist of user interface and peripheral devices that are connected to computer 1402 and controlled by terminal interface hardware included in the terminal I/F 1410 that includes video adapters and interfaces for keyboards, pointing devices, and the like.

An operating system (not shown) included in the main memory is a suitable multitasking operating system such as the Linux, UNIX, Windows XP, and Windows Server 2003 operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 1402. The network adapter hardware 1412 is used to provide an interface to a network 110. Embodiments of the present invention are able to be adapted to work with any data communications connections including present day analog and/or digital techniques or via a future networking mechanism.

Although the exemplary embodiments of the present invention are described in the context of a fully functional computer system, those skilled in the art will appreciate that embodiments are capable of being distributed as a program product via CD or DVD, e.g. CD 218, CD ROM, or other form of recordable media, or via any type of electronic transmission mechanism.

Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method, with an information processing system providing an interactive environment, for autonomously managing user orders associated with at least one vendor, the method comprising:
receiving, through the interactive environment, an order from a user for at least one item offered by at least one vendor;
retrieving vendor account information associated with the user for the at least one vendor;
autonomously and without user intervention logging into the at least one vendor using the vendor account information associated with the user; and
autonomously and without user intervention providing information associated with the order as prompted by the vendor on behalf of the user to place the order with the at least one vendor.

2. The method of claim 1, wherein the vendor account information is provided by the user during an account setup process for the interactive environment.

3. The method of claim 1, wherein the vendor account information is provided to the interactive environment at a time the user submits the order to the interactive environment.

4. The method of claim 1, wherein the at least one vendor is a food purveyor.

5. The method of claim 1, wherein the logging into the at least one vendor using the vendor account information associated with the user further comprises:
querying the at least one vendor to obtain pricing information for each item in the order.

6. The method of claim 5, further comprising:
determining that the pricing information that has been obtained from the querying is different than current pricing information for at least one item in the order; and
notifying, prior to providing the information to place the order, the user that pricing information has changed for the at least one item.

7. The method of claim 1, further comprising:
receiving a request from the user to create the order; and
retrieving order information associated with the user, wherein the order information is associated with at least one order previously placed by the user at the at least one vendor.

8. The method of claim 7, wherein the order information is retrieved by:
autonomously and without user intervention logging into the at least one vendor using the vendor account information associated with the user.

9. The method of claim 7, further comprising:
retrieving information associated with a set of items offered by the at least one vendor by:
autonomously and without user intervention logging into the at least one vendor using the vendor account information associated with the user.

10. The method of claim 7, further comprising:
receiving, from the user, a selection of at least one item from the order information; and
displaying to the user another item that is substantially comparable to the at least one item.

11. The method of claim 10, wherein the item is determined to be substantially comparable to the at least one item by at least one of:
receiving an indication from the user that the another item is substantially comparable to the at least one item;
automatically comparing at least one of item number, item description, and item packaging of the another item and the at least one item; and
receiving input from other users that indicates the another item is substantially similar to the at least one item.

12. The method of claim 10, wherein the item is determined to be substantially comparable to the at least one item by:
identifying at least one of a set of abbreviations and a set of synonyms associated with the at least one item that has been selected; and
comparing the at least one of a set of abbreviations and a set of synonyms associated with the at least one item that has been selected with an information set associated with the another item.

13. The method of claim 1, further comprising:
displaying a recipe cost analysis to the user, wherein the recipe cost analysis comprises cost information for each ingredient in the recipe based on at least one of a current order, a previous order, and a given number of orders over a given period of time.

14. The method of claim 1, further comprising:
displaying a packaging information set for each item in a plurality of items, wherein the packaging information set at least includes a unit of measurement;
determining that at least one of the packaging information sets fails to include a unit of measurement in a standardized format; and
converting the unit of measure that fails to be in a standardized format into the standardized format.

15. An information processing system that provides an interactive environment and autonomously manages user orders associated with at least one vendor, the information processing system comprising:
a memory;
a processor;
an interactive environment; and
an interactive environment manager, wherein the interactive environment manager is adapted to:
receive, through the interactive environment, an order from a user for at least one item offered by at least one vendor;
retrieve vendor account information associated with the user for the at least one vendor;
autonomously and without user intervention log into the at least one vendor using the vendor account information associated with the user; and
autonomously and without user intervention provide information associated with the order as prompted by the vendor on behalf of the user to place the order with the at least one vendor.

16. The information processing system of claim 15, wherein the interactive environment manger is further adapted to:
receive a request from the user to create the order; and
retrieve order information associated with the user, wherein the order information is associated with at least one order previously placed by the user at the at least one vendor, wherein the order information is retrieved by autonomously and without user intervention logging into the at least one vendor using the vendor account information associated with the user.

17. The information processing system of claim 16, wherein the interactive environment manger is further adapted to:
retrieve information associated with a set of items offered by the at least one vendor by:
autonomously and without user intervention logging into the at least one vendor using the vendor account information associated with the user.

18. A computer readable storage product that provides an interactive environment and autonomously manages user orders associated with at least one vendor, the computer readable storage product comprising instructions for:
receiving, through the interactive environment, an order from a user for at least one item offered by at least one vendor;
retrieving vendor account information associated with the user for the at least one vendor;
autonomously and without user intervention logging into the at least one vendor using the vendor account information associated with the user; and
autonomously and without user intervention providing information associated with the order as prompted by the vendor on behalf of the user to place the order with the at least one vendor.

19. The computer readable storage product of claim 18, further comprising instructions for:
receiving a request from the user to create the order; and
retrieving order information associated with the user, wherein the order information is associated with at least one order previously placed by the user at the at least one vendor, wherein the order information is retrieved by autonomously and without user intervention logging into the at least one vendor using the vendor account information associated with the user.

20. The computer readable storage product of claim 18, further comprising instructions for:
retrieving information associated with a set of items offered by the at least one vendor by:
autonomously and without user intervention logging into the at least one vendor using the vendor account information associated with the user.
